(19) United States
(12) Patent Application Publication
(10) Pub. No.: US 2012/0154911 A1
(43) Pub. Date: Jun. 21, 2012

(54) Car Mirror Cover

(76) Inventors: Eric Huynh, Tarzana, CA (US); Colin Russeh Anderson, Los Angeles, CA (US); Shahed Hyder, Woodland Hills, CA (US)

(21) Appl. No.: 12/969,905

(22) Filed: Dec. 16, 2010

(51) Int. Cl. B60J 11/06

(52) U.S. Cl. 359/511

(57) ABSTRACT

A cover for a side view mirror of a car having a shell attached to the car where the shell has a closed side facing the front of the car, an open end facing the rear of the car and a movable mirror located in the open end of the shell. The cover, which may be a blend of material, covers the closed side of the shell and may have a display printed thereon visible from the front of the car. An elastic draw string is located in a channel of the cover or Velcro strips are located on the inside surface of the cover. The cover is attached to the side view mirror by placing the ends of the channel around the side view mirror and fastening the ends of the elastic draw string together after pulling them tight or engaging Velcro strips located on the shell.

### BACKGROUND OF THE INVENTION

1. Field of the Invention

The present invention relates generally to a car side view mirror and more specifically to a shield for covering a car side mirror, where the shield includes a protective cover for effectively covering and protecting the car side mirror against damage from stones and bugs. The shield can include a display of an insignia or a country flag on the side of the cover facing the front of the car where the display may be covered with a reflective material such as glass beads which may be clear or colored and allows the display to be seen in the daytime and where head lights of approaching cars will illuminate the display during the night time

2. Description of Related Art

Covers for car side view mirrors is known in the prior art. More specifically, by way of example, U.S. Pat. No. 7,121,028 to Shoen discloses a display having a rearview mirror with a reflective surface. The display includes a label having an adhesive side and a display side, and a size and a shape that covers a portion of the reflective surface of the rearview mirror. The adhesive side of the label is affixed to the rearview mirror such that the rearview mirror is converted into an information display.

U.S. Pat. No. 6,941,690 to McCambley, Jr. discloses colored, dyed stretchable materials arranged to form display indicia which fit on the three-dimensional curvilinear shape of a car side view mirror. The material forms display indicia which faces the front of the car without obstructing the view of the mirror surface facing the rear of the vehicle.

U.S. Pat. No. 6,769,798 to Mishimagi discloses a side view mirror cover that has a mirror cover body and a cover lamp. The lamp has a lamp housing having plural light emitting elements and a translucent lamp cover for covering the elements. The light emitting elements include LEDs for emitting light toward the front and the side of the car, respectively.

U.S. Pat. No. 6,467,918 to Strode discloses a device for displaying indicia which fits onto a mirror housing of an exterior mirror of a motor vehicle. The device, upon installation, displays a desired indicia facing the front of the vehicle without obstructing the view of the mirrored surface facing the rear of the vehicle.

U.S. Pat. No. 6,325,121 to Hudnall discloses a side view mirror cover having a bonnet-like cover portion which conforms to the exterior shape of the side view mirror housing. An elastic gather is provided along the open rear of the cover and a pair of securement straps are provided for bringing together the ends of the elastic gather.

U.S. Pat. No. 5,133,141 to Bane discloses a vehicle rearview mirror cover or sock of stretchable or flexible material adapted to be snugly fitted on the reverse side of an interior vehicle rearview mirror. Indicia such as a trademark, service mark, name, logo, emblem, or the like may be disposed on the back of the cover so as to be easily viewed from the front area of the vehicle.

U.S. Pat. No. 5,115,848 to Malone discloses covers for protecting the exposed glass surfaces of an external car mirror. The mirror covers comprise bag-like enclosures of weather resistant material which totally enclose the mirror to prevent the formation of ice, frost or snow buildup.

U.S. Pat. No. 4,834,157 to Smith discloses a removable cover which protects the exterior exposed surface of a side view mirror of a car from blemishes, stains, scratches to which such surface is subjected during the normal travel of the car.

U.S. Pat. No. 5,421,628 to Nahm discloses a water-repellant shield for an automobile side view mirror which includes a water-repellant cover and an extension cover or a collapsible extension cover which extends from the water-repellant covering to protect the side mirror from rain.

### SUMMARY OF THE INVENTION

In an exemplary embodiment of the present invention, there is disclosed a cover for a side view mirror of a car having a shell attached to the car via a horizontal support member where the shell has a closed side facing the front of the car, an open end facing the rear of the car and a movable mirror located in the open end of the shell and facing the rear of the car. The cover, which can be made of a blend of different fabrics or materials, covers the closed side of the shell and has a display printed thereon which is visible from the front of the car. The cover includes a channel which is located around its perimeter. An elastic draw string which is located in the channel around the perimeter of the cover is used to attach the cover to the side view mirror. In use, the cover is attached to the car side view mirror by placing the channel around the horizontal support member and, after pulling the elastic draw string tight, fastening the ends of the elastic draw string together by tying or with one or more clips.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a view of the rear of a side view mirror for a car where the mirror is located in a shell which is attached to a car;

FIG. 2 is a view of the side view mirror of FIG. 1 with a protective cover wrapped around the shell and having a display which faces the front of the car;

FIG. 3 is a view of the protective cover with a display which is wrapped around the shell of the side view mirror of a car;

FIG. 4 is a view of the front of the side view mirror of FIG. 2 showing a cover where the ends of the tie string have not been fastened together;

FIG. 5 is a sectional view along the line 5-5 of FIG. 3 showing reflecting ink, paint or glass beads that may be in the display on the cover;

FIG. 6 is a perspective view of an embodiment of a protective cover such as a sock having one or more strips of Velcro which are positioned to engage one or more strips of Velcro attached to the shell of the mirror; and

FIG. 7 is a perspective view of another embodiment of a protective cover such as a sock having means other than strips of Velcro such as, for example, an elastic band for attaching the cover to the shell of the mirror.

### DESCRIPTION OF THE PREFERRED EMBODIMENT

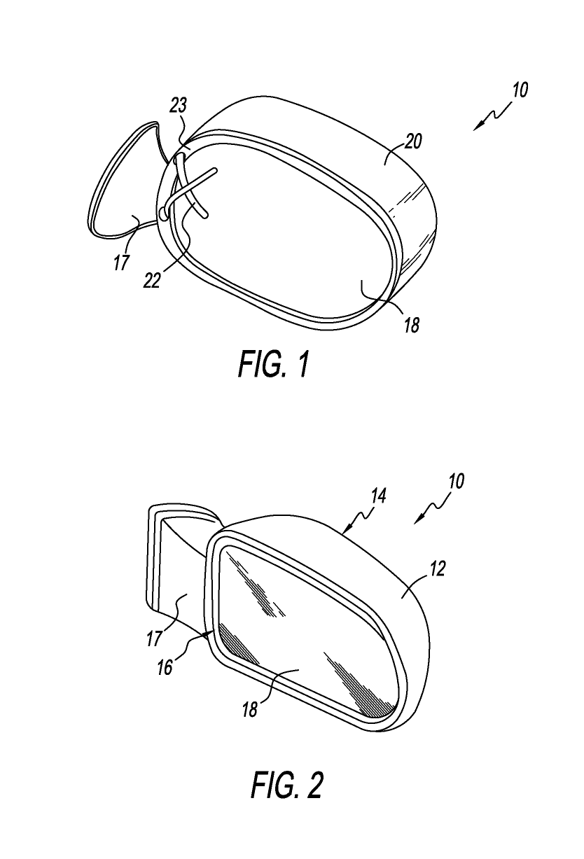

Referring to FIG. 1, there is shown a view of the rear of a side view mirror 10 of a car and, looking at FIG. 2, there is shown the rear of the side view mirror 10 of a car having a shell 12 with a forward facing side 14 and a rearward facing side having an open area 16. The rearward facing side of the shell includes a mirror 18 which is spaced from the shell to allow the mirror to be adjusted left, right, up and down without moving the shell. The shell and mirror are normally attached to a car door via a horizontal support member 17 to allow a person driving the car to view back ward along the sides of the car. A cover 20 (see FIG. 1) which is located over the forward facing side 14 of the shell is a sleeve which may be made of a blend of two or more fabrics or materials where at least one of the fabrics of the blend may have elastic properties. The cover includes an elastic drawstring 22 which is located in a channel 23 which is located around the perimeter of the sleeve and includes an opening for the ends of the drawstring to exit the channel. In an embodiment the shell and/or sleeve may have attachment means such as strips of Velcro or a releasable adhesive which can be used to secure the sleeve to the shell.

Referring to FIG. 4, there is shown the cover 20 which is shaped to fit over the forward facing side of the shell with the elastic drawstring 22 located around the perimeter of the cover which fits over the edge of the shell without interfering with or covering any portion of the mirror. The cover has an opening 25 which is provided to receive the horizontal support member 17. In use, the cover is placed over the front side of the shell with the horizontal support member located in opening 25. The ends of the drawstring are placed around the horizontal support member 17, are then drawn tight and fastened together with at least one clip, which may be made of a plastic or stainless steel, by tying the ends together to hold the cover to the shell of the side view mirror, or by attaching the ends of the drawstring together with strips of material having hooks and loops (Commonly known as Velcro) which are attached to the ends of the drawstring.

The cover can be oblong, square or round where the size of the cover will vary according to the size of the side view mirrors of the car.

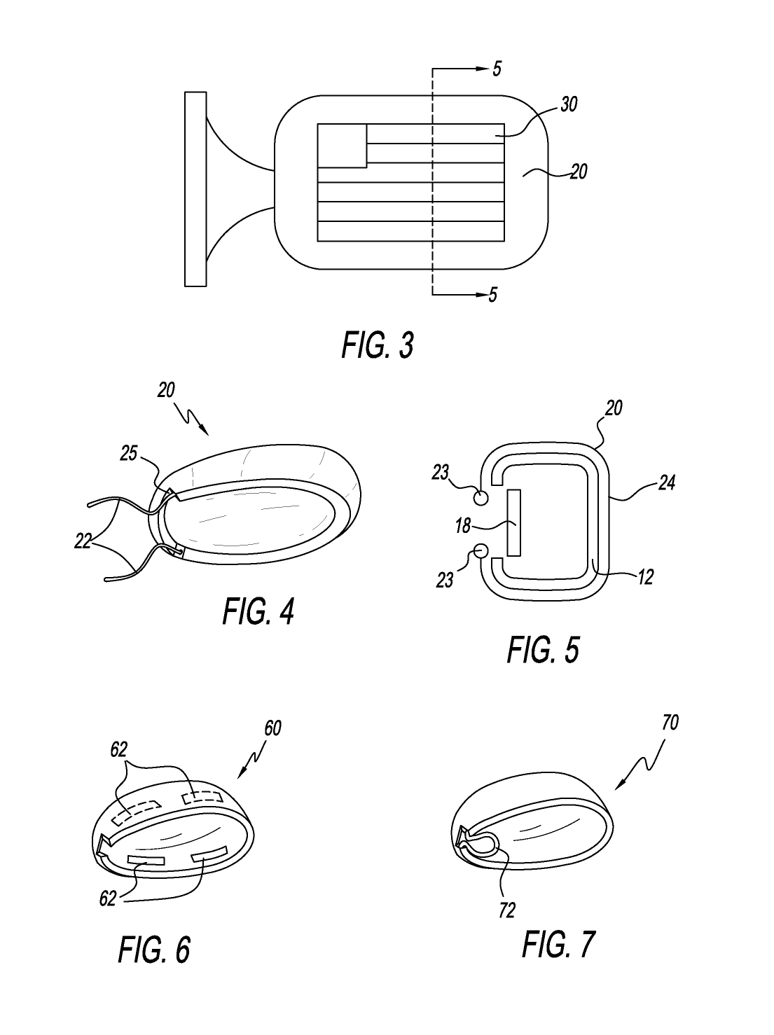

FIG. 4 shows a view of the front of the side view mirror of FIG. 2 where the cover can have a display of an emblem, a symbol, a country flag, a sporting team flag, a logo, advertising, a saying, etc. The display can be in one or more colors and, if desired, may be in reflecting ink or an ink which may includes small light reflecting glass beads which allows the display to be seen during the day and at night by reflecting the head lights of an oncoming car. The display in FIG. 3 is of the American flag 30 where the colors of red, white, and blue each may be in a non-reflecting ink or in a reflecting ink.

Referring to FIG. 5, there is shown a sectional view along the line 5-5 of FIG. 3 showing the cover 20 on the shell where, optionally, the cover may have reflecting material 24 such as reflecting ink or paint on the surface of the cover. The reflecting material on the surface of the cover can be selectively located over specific areas of the cover such as only on the red and white stripes of the American flag.

Referring to FIG. 6, there is shown a perspective view of an embodiment of the protective cover 60 such as a sock having one or more strips of Velcro 62 which are positioned on the inside surface of the cover to engage one or more strips of Velcro attached to the shell of the mirror.

Referring to FIG. 7, there is shown a perspective view of another embodiment of the protective cover 70 such as a sock having means other than strips of Velcro such as, for example, an elastic band 72 for attaching the cover to the shell of the mirror.

The cover may be made of a flexible material which is a laminate of a layer of woven or nonwoven material, or optionally of a plastic having a layer reflecting ink or paint located on the surface of the cover to reflect the display during the night to oncoming traffic.

The cover can be made of stretch material such as elastic stretch knitted polyester, spandex, lycra or milk silk, of woven or nonwoven material, or of a flexible plastic. The cover may also be made of a blend of two or more of these various materials such as, for example, spandex mixed with polyester and/or lycra.

The display on the cover may be by a heat transfer process or any other process such as three color printing and may be a logo, a symbol, a slogan, an advertisement of a product or an event, a company name, etc. Thus, the automobile side view mirror can be a moving billboard.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A shield for a side view mirror of a car having a shell attached to the car via a horizontal support member where the shell has a closed side facing toward the front of the car, an open end facing the rear of the car and a movable mirror located in the open end of the shell and facing the rear of the car, the shield comprising:
a cover which covers the closed side of the shell having a display printed thereon which is visible from the front of the car;
a channel having two ends located around the perimeter of the cover; and
an elastic draw string located in the channel around the perimeter of the cover having two ends that exit the channel through the two ends;
wherein the cover is attached to the side view mirror by placing the ends of the channel around the horizontal support member and pulling on the ends of the elastic draw string to reduce the length of the channel and fastening the ends together.

2. The shield of claim 1 wherein the cover is a blend wherein at least one of the materials is a woven material, a nonwoven material or a flexible plastic.

3. The shield of claim 2 wherein the cover is composed of a stretch material.

4. The shield of claim 3 wherein the stretch material is elastic stretch knitted polyester, lycra or milk silk.

5. The shield of claim 2 wherein clips are provided to attach the cover to the shell.

6. The shield of claim 2 wherein the display is placed on the surface of the cover with a heat transfer process.

7. The shield of claim 2 wherein the display is a country flag, a sporting flag, a logo, an advertisement or a saying.

8. The shield of claim 7 wherein reflecting material is located on the surface of the cover on top of the printed display.

9. The shield of claim 8 wherein the reflecting material is paint or ink.
